(19) United States
(12) Patent Application Publication
(10) Pub. No.: US 2016/0171960 A1
(43) Pub. Date: Jun. 16, 2016

(54) PROCESS FOR MANUFACTURING A RESISTIVE LAYER FOR AN ACOUSTIC PANEL,AND CORRESPONDING ACOUSTIC PANEL

(71) Applicant: Airbus Operations S.A.S., Toulouse Cedex 9 (FR)

(72) Inventors: Alain PORTE, Colomiers (FR); Bertrand RIVES, Toulouse (FR)

(21) Appl. No.: 14/969,287

(22) Filed: Dec. 15, 2015

(30) Foreign Application Priority Data
Dec. 16, 2014 (FR) 1462473

(51) Int. Cl. G10K 11/168; B32B 3/12; B32B 5/16; C23C 4/134

(52) U.S. Cl. CPC G10K 11/168; C23C 4/134; B32B 3/12; B32B 5/16; B32B 2305/024; B32B 2307/724; B32B 2307/102; B32B 2605/18

(57) ABSTRACT

The embodiment relates to a process for manufacturing a resistive layer for an acoustic panel, comprising a step of manufacturing a wall containing apertures distributed over its surface, making it air-permeable, and a step of depositing, on a face of said wall, particles of diameter comprised between 0.05 μm and 5 μm, until a coating of thickness comprised between 0.02 mm and 0.5 mm is formed on this face, partially blocking the apertures.

### CROSS-REFERENCE TO RELATED APPLICATION

This application claims priority to French Patent Application No. 1462473, filed Dec. 16, 2015, which is incorporated herein by reference in its entirety.

### TECHNICAL FIELD

the embodiments described herein relate to a process for manufacturing a resistive layer for an acoustic panel. This also relates to an acoustic panel, usable especially in the manufacture of aircraft.

### BACKGROUND

The aim of acoustic panels is to absorb and damp the sound waves that they receive. Among the various types of known panels, the panels that are commonly referred to as “sandwich” panels generally include a plurality of layers. A first layer, called the “resistive layer”, consists of an air-permeable material and forms the exterior surface of the panel. A second layer, forming the core of the panel, is formed from a cellular material, such as a material with a “honeycomb” structure. A third layer forms a total reflector. Preferably, each cell of the core of the panel is closed by the first layer at one of its ends and by the third layer at the other of its ends.

In this conventional arrangement of “sandwich” type acoustic panels, the resistive layer has a dissipative role. When a sound wave passes therethrough, viscous effects are produced that convert the acoustic energy into heat. The cells of the core of the panel have dimensions tailored to the wavelengths of the sound waves to be attenuated. Closed, at their end opposite to the exterior surface of the panel, by the third layer forming a total reflector, these cells form quarter-wave resonators that have the effect of damping the sound waves. Such “sandwich” type acoustic panels are, for example, described in documents FR 2 815 900.

To ensure an acoustic panel is of satisfactory effectiveness, the level of air-permeability of the resistive layer must be adjusted as precisely as possible, in order to allow the frictional dissipation of the acoustic waves to be optimised for a sound level and for a speed of fluid flow over this surface. Moreover, the apertures in this resistive layer generating its air-permeability must be, as far as is possible, distributed over the surface of the resistive layer, in order to supply the various cells of the core of the acoustic panel uniformly.

In certain acoustic panels, the resistive layer consists of a perforated metal or composite sheet. The improvement in the performance of these panels is then limited by the minimum size of the holes drillable in the sheet. Specifically, it is difficult to drill holes of diameter smaller than 1 mm with conventional drilling techniques, or smaller than 0.3 mm with advanced drilling techniques. Moreover, the dimensional tolerances of holes of such small diameter are large, relative to their diameter, meaning that the level of air-permeability of a sheet drilled with holes of too small a diameter cannot be adjusted with precision.

In other panels, the resistive layer consists of a microporous layer for example including a porous woven composed of fibres. In such panels, the level of air-permeability of the resistive layer can again not be adjusted with a high precision. Specifically, the level of air-permeability of such microporous layers can be chosen, during their manufacture, only with a low precision. In addition, during manufacture of the acoustic panel, the microporous layers are fixed in a configuration in which they are stretched to a greater or lesser degree, thereby possibly modifying their level of air-permeability.

There is therefore a need for acoustic panels including a resistive layer containing apertures better distributed over the surface of the resistive layer, and providing a level of air-permeability that is adjusted very precisely.

It is an object of the present embodiment to provide a process for manufacturing an acoustic panel in which the air-permeability of the resistive layer is better distributed over the surface of this resistive layer, and may be adjusted very precisely.

### SUMMARY

These objectives, and others that will become more clearly apparent below, are achieved by in a process for manufacturing a resistive layer for an acoustic panel, comprising: manufacturing a wall containing apertures distributed over its surface, making it air-permeable; and depositing, on a face of the wall, particles having a diameter between 0.05 μm and 5 μm, until a coating of thickness comprised between 0.02 mm and 0.5 mm is formed on the face, partially blocking the apertures.

Such a process allows, by partially blocking the apertures of the resistive layer, the air-permeability of this resistive layer to be modified. In addition, since this blocking of the apertures is carried out using very fine particles, it enables very precise adjustment of the degree of air-permeability of the resistive layer.

According to one preferred embodiment, the wall is produced from a sheet in which a plurality of holes are drilled.

According to another preferred embodiment, the wall consists of at least one textile layer.

Preferably, the particles are deposited by at least one plasma torch that sprays the particles onto the face in a plasma beam.

Advantageously, the plasma torch(es) spray the particles onto the face in at least two successive layers of particles, the orientation of the plasma beam relative to the wall being different for the spraying of each of the layers of particles.

Preferably, the process comprises, between the step of manufacturing an air-permeable wall and the step of depositing particles: a step of measuring the degree of air-permeability of the air-permeable wall; and a step of determining characteristics of the coating to apply to obtain a preset degree of air-permeability.

This also relates to an acoustic panel, comprising a core in which cells are defined, and an air-permeable resistive layer covering the core and blocking at least certain of the cells, in which the resistive layer is manufactured according to the process described above.

### BRIEF DESCRIPTION OF THE DRAWINGS

The various embodiments will hereinafter be described in conjunction with the following drawing figures, wherein like numerals denote like elements, and:

FIG. 1 is a schematic cross-sectional view of a “sandwich” type acoustic panel comprising an external resistive layer formed by a drilled sheet;

FIG. 2 is a schematic cross-sectional view of a “sandwich” type acoustic panel comprising an external resistive layer formed by a woven;

FIG. 3 is a cross-sectional detail view of the external resistive layer implemented in the acoustic panel in FIG. 1;

FIG. 4 is a cross-sectional detail view of the external resistive layer implemented in the acoustic panel in FIG. 2;

FIG. 5 schematically shows a step in the manufacture of the external resistive layer in FIG. 3, with a process according to one embodiment;

FIG. 6 schematically shows a step in the manufacture of the external resistive layer in FIG. 3, with a process according to another embodiment; and

FIG. 7 shows the succession of steps used to manufacture an external resistive layer of an acoustic panel, in a manufacturing process according to one embodiment.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

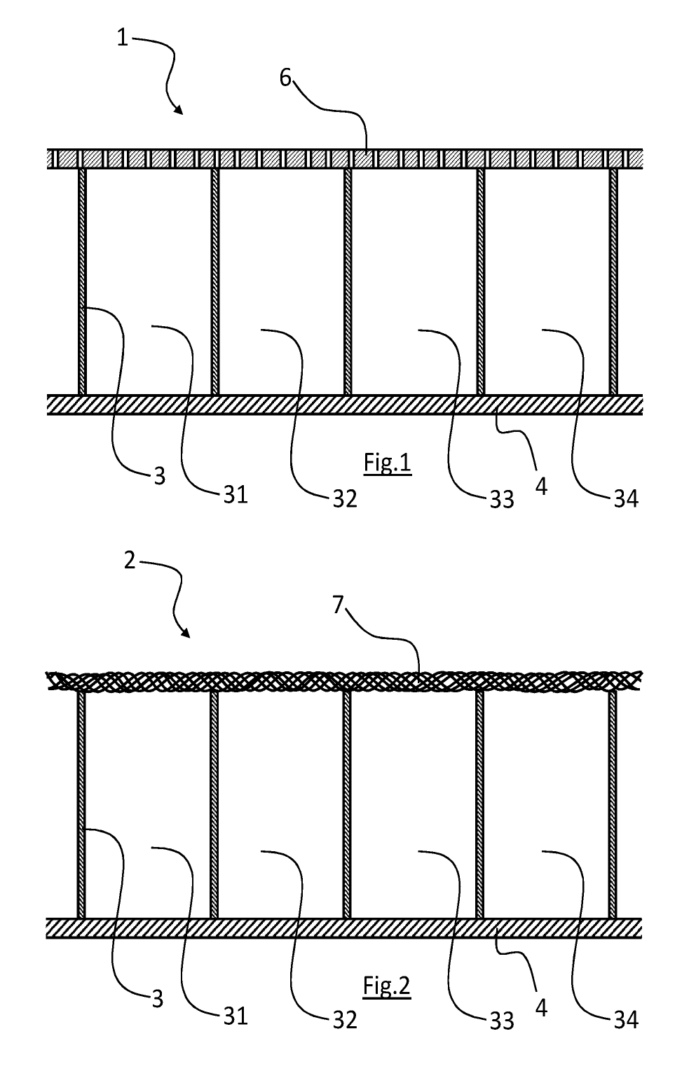

FIG. 1 schematically shows, in cross section, an acoustic panel 1 of the “sandwich” type. Conventionally, this panel includes: a resistive first layer 6, formed by a sheet drilled with a plurality of holes, forming the exterior surface of the panel 1; a second layer 3, forming the core of the acoustic panel 1, said layer being formed by a cellular material, such as a material with a “honeycomb” structure (only the partitions separating the cells 31, 32, 33, 34 defined in this second layer are shown in FIG. 1); and a third layer 4 forming a total reflector.

Each cell 31, 32, 33, 34 of the second layer 3 of the panel is closed by the first layer 6 at one of its ends and by the third layer 4 at the other of its ends.

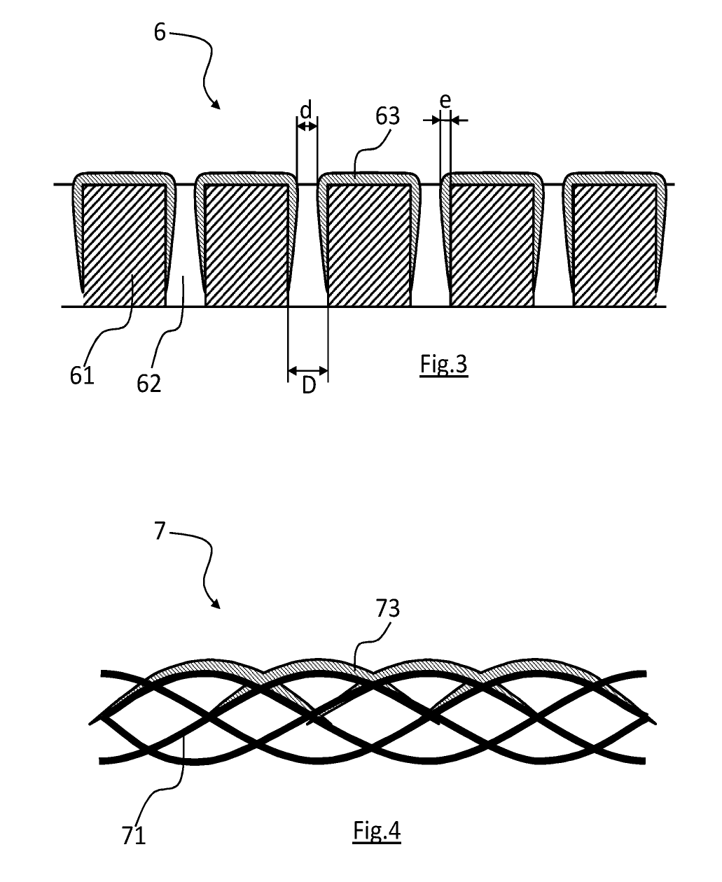

FIG. 3 is a schematic cross-sectional detail view of the external resistive layer 6 implemented in the acoustic panel 1, according to one embodiment. In this figure, the external face of the resistive layer 6 is, by convention, its upward-turned face.

This resistive layer 6 is based on a sheet 61, which may for example be made of metal or a composite, in which a plurality of holes 62 are drilled.

These holes may be drilled using a drill, thereby allowing holes of diameter of about 1 to 1.5 mm to be obtained. They may also be obtained by known sandblasting, water jet or laser drilling methods, which allow holes of diameter of about 0.3 to 0.8 mm to be obtained. In another possible embodiment, these holes may be oblong slits the width of which is larger than or equal to 0.2 mm and the length of which larger than or equal to 0.5 mm. In the embodiment shown in the figures, the holes 62 are round and are drilled in the sheet 61 with a diameter D of about 0.8 mm.

The level of air-permeability of the resistive layer 6 is given by the ratio of the area of the holes to the area of the sheet containing these holes. This level of air-permeability therefore depends both on the number of holes and the cross section of the holes (their diameter, for round holes). To implement the embodiment, the sheet is intentionally drilled with holes the number and diameter of which lead to a level of air-permeability higher than the level of air-permeability sought for the resistive layer 6.

As FIG. 3 shows, the external face of the resistive layer 6 is covered, after the holes 62 have been drilled, with a coating 63. This coating 63 also covers some of the cylindrical surface of the holes 62, thereby having the effect of decreasing the effective diameter of these holes to a diameter d smaller than the diameter D of the bore of the original hole.

By way of example, in the embodiment shown, the thickness e of the coating 63 at the top of the cylindrical surface encircling the holes 62 is 0.25 mm. If the diameter D of the original bore of the holes 62 is 0.8 mm, the effective diameter d of the holes 62 after the coating 63 has been applied, calculated using the formula d=D−2×e, is then equal to 0.3 mm.

It is thus possible to thus decrease very substantially the dimensions of each hole, and therefore the level of air-permeability of the resistive layer 6 relative to the level of air-permeability of the sheet 61 before application of the coating 63.

Use of the coating 63 therefore allows a resistive layer 6 comprising a large number of holes 63 of small diameter d to be manufactured from a sheet 61 comprising bores of larger diameter D, which are easier to produce than bores of small diameter d. It is thus easy, to produce a resistive layer 6 having a given level of air-permeability, to obtain this air-permeability with a larger number of holes than in the prior art, having a smaller diameter than in the prior art. It is thus possible to produce a resistive layer 6 that allows the various cells of the core of the panel to be more uniformly supplied than was the case with prior-art solutions. Moreover, the thickness of the deposited coating may be adjusted with precision, thereby allowing the air-permeability of the resistive layer 6 to be precisely adjusted.

FIG. 3 shows a resistive layer 6 formed from a sheet containing substantially cylindrical holes 62. It is however possible, in other embodiments, to implement the proposed technical solution with a resistive layer containing holes of different shape, for example of oblong cross section or of a conical shape.

FIG. 2 schematically shows, in cross section, an acoustic panel 2 of the “sandwich” type according to another embodiment. Conventionally, this acoustic panel 2 includes: a resistive first layer 7, formed by a metal woven, forming the exterior surface of the panel 2; a second layer 3, forming the core of the acoustic panel 2, which layer is formed by a cellular material, such as a material with a “honeycomb” structure (only the partitions separating the cells 31, 32, 33, 34 defined in this second layer are shown in FIG. 1); and a third layer 4 forming a total reflector.

Each cell 31, 32, 33, 34 of the second layer 3 of the panel is closed by the first layer 7 at one of its ends and by the third layer 4 at the other of its ends.

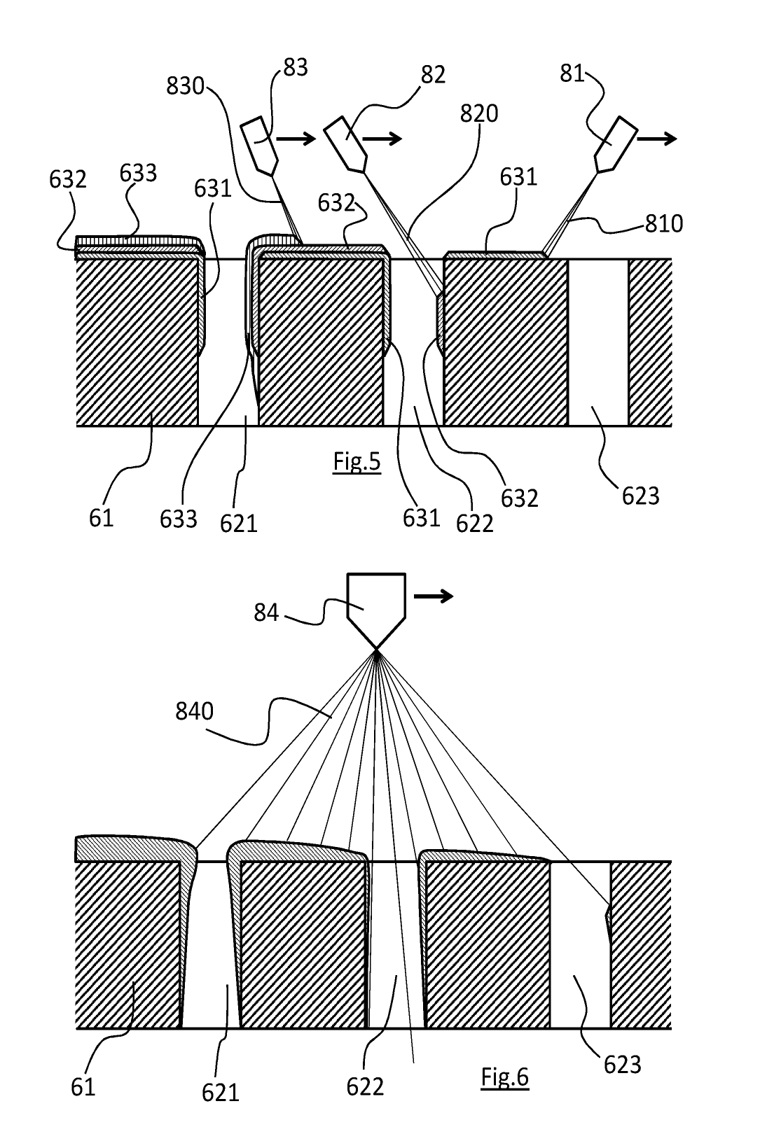

FIG. 4 is a schematic cross-sectional detail view of the external resistive layer 7 implemented in the acoustic panel 2, according to one embodiment. In this figure, the external face of the resistive layer 7 is, by convention, its upward-turned face.

This resistive layer 7 may comprise one or more layers of wovens, for example wovens of metal fibres, or of nonwoven textile material comprising metal or nonmetal fibres. In the embodiment shown, the resistive layer is formed from a woven 71 formed from a plurality of metal threads. The spaces between the metal threads form passages for air, generating the air-permeability of this woven 71. To implement the embodiment, the woven 71 used is chosen to have a level of air-permeability higher than the level of air-permeability sought for the resistive layer 7.

As FIG. 4 shows, the external face of the resistive layer 7 is covered with a coating 73. This coating 73 covering the threads forming the woven 71 has the effect of decreasing the size of the spaces allowing air to pass through the woven 71. It therefore allows the level of air-permeability of the resistive layer 7 to be decreased relative to the level of air-permeability of the woven 71 before application of the coating 73. It is thus possible, by adjusting the thickness of the deposited coating with precision, to carry out a precise adjustment of the air-permeability of the resistive layer 7.

The acoustic panels in FIGS. 1 and 2 are merely exemplary acoustic panels to which the embodiment may be applied. Specifically, the embodiment may also be applied to any other acoustic panel in which a resistive porous layer blocks cells or a cavity. Thus, a similar coating to that described above may be applied to other types of resistive layers known in the art, especially resistive layers made up of a combination of a rigid structure, such as a grille or a sheet drilled with holes, and one or more layers of wovens or of nonwoven textiles.

In the embodiments shown, the coating 63 or 73 applied to the exterior surface of the resistive layer is composed of fine particles, of average diameter comprised between 0.05 μm and 5 μm, which particles are sprayed or deposited onto the external surface of a wall, formed by an apertured sheet or by a woven, so as to form a coating layer the average thickness of which is comprised between 0.02 mm and 0.5 mm.

Preferably, these particles are sprayed at least partially in a direction that is not parallel to the axes of the holes in the wall, so that the coating is sprayed onto the surfaces bounding these holes and thus decreases the size of the holes.

The use of fine particles to form the coating allows the thickness of this coating to be very precisely adjusted. Specifically, since the particles have a size very much smaller than the thickness of the coating, it is necessary to spray a large number thereof to obtain the final coating. The coating is thus obtained gradually, thereby allowing its thickness to be very tightly controlled.

Preferably, the particles used are mineral, ceramic and/or metal particles. The use of such particles makes it possible to manufacture a resistive layer that withstands well the erosion that possibly caused wear of acoustic panels of the prior art, especially those located on the fuselage of an aircraft. The present embodiment may therefore allow those zones of an aircraft that are most subject to erosion to be equipped with acoustic panels, which was not previously possible, thereby allowing the overall acoustic performance of the aircraft to be increased.

FIG. 5 shows the step of spraying particles forming the coating 63 onto a sheet 61 drilled with holes 621, 622 and 623, according to a first possible embodiment of the embodiment.

In this embodiment, the coating is sprayed onto the sheet 61 by a plurality of torches 81, 82 and 83, each spraying a directional jet 810, 820 and 830, respectively, of particles onto the exterior surface of the sheet 61.

Each of these torches 81, 82 and 83 may for example be a plasma torch forming an atmospheric plasma beam, consisting of ionised gas in which the particles to be sprayed are included. In the plasma beam, these particles are heated until they melt and are sprayed toward the sheet. In certain cases, these particles may also undergo chemical transformations in this plasma beam, especially due to the heat. On contact with the surface of the sheet, the particles solidify thereon so as to form a coating layer.

According to one preferred embodiment, the particles implemented to manufacture the coating are dispersed beforehand in a liquid in order to form a sol-gel type compound that is itself inserted into the beam of the plasma torch. The use of such a sol-gel process allows a good particle size distribution to be obtained for the particles to be sprayed.

The formation of such a sol-gel type compound containing fine particles, and the introduction of this sol-gel type compound into a plasma beam allowing the particles to be sprayed onto a substrate in order to form thereon a thin coating layer, are especially described by documents WO2006/043006 and WO2007/122256.

In the embodiment shown in FIG. 5, the three plasma torches 81, 82 and 83 each move from left to right while spraying particles intended to form the coating. Each of these torches thus deposits on the surface a separate layer of particles. Thus, FIG. 5 shows a first layer 631 of particles deposited by the torch 81 on that surface of the sheet 61 which is turned toward the exterior and on one portion of the surface bounding the holes 621 and 622, a second layer 632 of particles deposited by the torch 82 on the first layer 631 of particles and on another portion of the surface bounding the holes 621 and 622, and a third layer 633 of particles deposited by the torch 83 on the second layer 632 of particles and on another portion of the surface bounding the hole 621.

As FIG. 5 shows, the torches 81, 82 and 83 each spray their particles in a direction making a different angle to the direction of the holes 621, 622 and 623. The various torches thus allow a coating to be formed on various portions of the surface bounding the holes 621, 622 and 623. Of course, the embodiment may be implemented with a larger number of torches than that shown in FIG. 5. It may also be implemented with a single torch that is passed a number of times, with different inclinations, over each point of the sheet 61. The movements of the torch(es) are preferably controlled by a robot that moves the torch(es) so that a certain number of particle spraying operations are carried out at different spraying angles at each point of the sheet 61.

Therefore, the coating deposited on the sheet 61 is composed of a large number of successive layers, preferably more than ten layers. Since it is possible to set the quantity of particles deposited in each layer precisely, it is possible to produce a coating having a very precise thickness, by adapting the number of layers. The degree of blockage of the holes 621, 622 and 623 may therefore also be chosen very precisely, especially by choosing the number of layers of particles deposited and the angle of inclination of the torch depositing each layer of particles.

FIG. 6 shows the step of spraying particles forming the coating onto a sheet 61 drilled with holes 621, 622 and 623, according to another possible embodiment.

According to this embodiment, the particles are sprayed by a torch 84 that disperses the particles intended to form the coating non-directionally. This torch may be a plasma torch of the same type as that described in the embodiment in FIG. 5, but it is configured so that the plasma beam 840 is emitted with a large dispersion angle.

The torch 84 moves from left to right, and the coating layer forms as it passes. In this embodiment, the thickness of the coating may be set with precision by choosing the speed at which the torch 84 moves.

It will be noted that the step of depositing particles to form the coating may be carried out using processes other than the spraying of particles in a plasma beam. It is thus possible to use other processes known in the art of depositing fine particles of this size, such as for example gas-phase particle deposition.

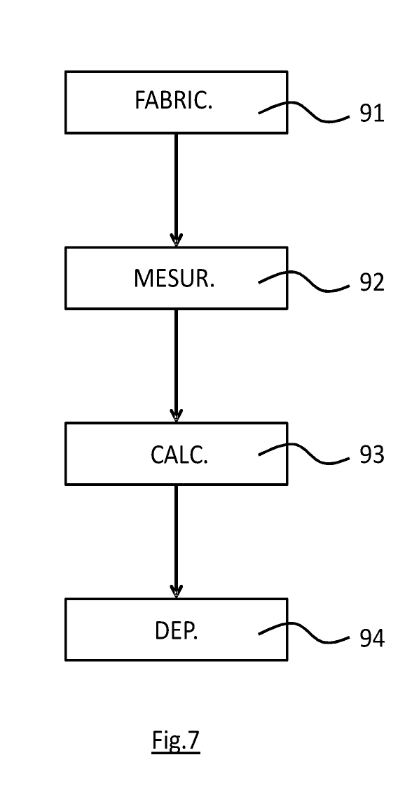

FIG. 7 schematically shows the steps of the process for manufacturing the resistive layer of an acoustic panel, according to one particular embodiment. This process comprises the following steps: a step “FABRIC.” 91 of manufacturing an air-permeable wall; a step “MESUR.” 92 of measuring the degree of air-permeability of the air-permeable wall; a step “CALC.” 93 of determining characteristics of the coating to be applied to obtain a preset degree of air-permeability; and a step “DEP.” 94 of depositing particles on that face of the air-permeable wall which is intended to be turned toward the exterior, until a coating having the characteristics set in the preceding step is formed thereon.

The step 91 of manufacturing an air-permeable wall may be carried out, for example, by drilling a metal or composite sheet with known processes, or by manufacturing a textile layer.

The step 92 of measuring the degree of air-permeability of the air-permeable wall may be carried out by measuring the head loss generated by the wall in an airflow. This step may be carried out with a conventional measuring device, known to those skilled in the art.

The step 93 of determining characteristics of the coating to be applied may be carried out by calculating the difference between the degree of air-permeability of the air-permeable wall and the degree of air-permeability desired for the resistive layer, and by determining, using a chart, the characteristics of the coating allowing the cross section of the apertures in the wall to be decreased enough to obtain the desired degree of air-permeability. The chart may be produced, beforehand, via a series of trials aiming to measure the effect on the degree of coatings of varied thicknesses and characteristics. Moreover, the chart may be integrated into a computer program, in order to allow the step of determining characteristics of the coating to be carried out by a computer.

The step 94 of depositing particles until a coating is formed may be carried out according to one s described in the present application, the characteristics of the coating being determined especially by the number of layers of particles deposited, by the rate of advance of the torches, by the inclination of the torches, etc.

While at least one exemplary embodiment of the present embodiment (s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A process for manufacturing a resistive layer for an acoustic panel (1, 2), comprising:
manufacturing (91) a wall containing apertures distributed over its surface, making it air-permeable; and
depositing, on a face of the wall, particles of diameter between 0.05 μm and 5 μm, until a coating between 0.02 mm and 0.5 mm is formed on the face, partially blocking the apertures.

2. The manufacturing process according to claim 1, wherein the wall is produced from a sheet in which a plurality of holes are drilled.

3. The manufacturing process according to claim 1, wherein the wall consists of at least one textile layer.

4. The manufacturing process according to claim 1, wherein the particles are deposited by at least one plasma torch that sprays the particles onto the face in a plasma beam.

5. The manufacturing process according to claim 4, wherein the plasma torch(es) spray the particles onto the face in at least two successive layers of particles, the orientation of the plasma beam relative to the wall being different for the spraying of each of the layers of particles.

6. The manufacturing process according to claim 5, wherein between the step of manufacturing an air-permeable wall and the step of depositing particles, comprising:
measuring the degree of air-permeability of said air-permeable wall; and
determining characteristics of the coating to apply to obtain an preset degree of air-permeability.

7. An acoustic panel, comprising:
a core in which cells are defined, and an air-permeable resistive layer covering the core and blocking at least certain of the cells, wherein the resistive layer is manufactured by
manufacturing a wall containing apertures distributed over its surface, making it air-permeable; and
depositing, on a face of the wall, particles of diameter between 0.05 μm and 5 μm, until a coating between 0.02 mm and 0.5 mm is formed on the face, partially blocking the apertures.
